(19) United States
(12) Patent Application Publication
(10) Pub. No.: US 2010/0066813 A1
(43) Pub. Date: Mar. 18, 2010

(54) STEREO PROJECTION WITH INTERFERENCE FILTERS

(76) Inventor: Helmut Jorke, Ulm (DE)

Correspondence Address: PATENT CENTRAL LLC;Stephan A. Pendorf, 1401 Hollywood Boulevard, Hollywood, FL, 33020, US

(21) Appl. No.: 12/515,342

(22) PCT Filed: Nov. 19, 2007
(86) PCT No.: PCT/DE07/02088

§ 371 Date: May 18, 2009

(30) Foreign Application Priority Data
Nov. 19, 2006 (DE) 10 2006 054 713.6

(51) Int. Cl. H04N 13/02; H04N 13/04

(52) U.S. Cl. 348/46; 348/53; 348/E13.075; 348/E13.074

(57) ABSTRACT

The invention relates to a stereo projection system and a method for generating an optically perceptible three-dimensional pictorial reproduction. For each of the two perspective partial images (left or right) of the stereo image, regions of the visible spectrum, which are defined differently by colour filters, are masked in such a way that a plurality of only limited spectral intervals is transmitted in the region of the colour perception blue (B), green (G), and red (R). The position of the transmitted intervals is selected differently for the two perspective partial images. The number of transmitted intervals for the two perspective partial images is, according to the invention, selected as lower than 6 (b) either for the image generation or for the image detection by the stereo glasses, and equal to 6 (a). In the event of a reduced number (b), at least one transmitted interval for one of the perspective partial images is selected in transmission in the region of two colour perceptions blue (B), green (G) or red (R), and created by right-left permutation and subsequent combination with an adjacent interval. According to the permutated intervals, the associated image data is analogously permutated. In this way, the cost of the filters, especially interference filters for the stereo projection system or for the method for producing an optically perceptible, three-dimensional pictorial reproduction, is significantly reduced without considerably affecting the reproduction quality. The unpleasant flickering is also reduced.

The invention relates to a process for the stereoscopic replay of pictures, video clips, movies etc., or, as the case may be, a stereo projection system for the realization of such process.

A number of different techniques for three-dimensional replay exist today. The anaglyph technique has already been known for a long time: By simple red/green-separation of the two left/right partial pictures and then viewing of the combined image through filter glasses, which pass the red component only or the green component only to one eye, respectively, a stereoscopic impression is created for the viewer. The green color represents the left partial picture whereas the red color represents the right partial picture. A drawback of the system is the inherent necessity of color filtering, so that no realistic color rendering can be produced with this technique.

Another technique, occasionally used for television broadcasting, is the Pulfrich-Process. This process likewise requires viewing glasses for the spectator, where however the light path for one of the eyes is more strongly attenuated in brightness than for the other eye. Oftentimes color filter glasses are used for this process as well (for cost reasons), but only the difference in brightness between the left and right eye is of importance. The difference in brightness causes a slight delay in the visual information reaching the regions of the brain processing the optical information. If an image is moving perpendicular to the viewer, then the time delayed reception for one eye causes a parallax and the image is perceived sterically. The advantage of this process is the simplicity of the replay technique. A disadvantage is the fact that the image always needs to be in motion, which can be unpleasant for the viewer after some time. In addition, the image always needs to move into one direction, since otherwise the depth information would reverse. Also the speed of the movement needs to be kept constant to keep the depth information realistic.

In connection with computers, another process is often used. The left/right components are separated by shutter glasses which pass the light, e.g. from a monitor or projector, alternately to the left or right eye of the viewer by means of electrically controllable polarization filters. The shutter glasses are synchronized with the replay device (e.g. monitor) such that the displayed series of left/right partial pictures only reaches the intended eye. This process features a realistic color rendering but the brightness is significantly reduced since at any given time the image is only received (alternately) by one eye of the viewer (only half of the overall brightness of the monitor) and additionally the polarization filters already absorb some of the light (even during their transmitting phase). The constant alternation between left and right partial picture also requires a very high image refresh rate (min. 120 Hz-160 Hz) to suppress noticeable flickering.

Another process is based on the interference filter technology. DE 199 24 167 B4 describes a process for the generation of an optically three-dimensionally discernible image replay using interference filter technique or, as the case may be, a stereo projection system. Here two interference filters with slightly different spectral filtering are utilized for the projection. Each filter features three discrete narrow transmission bands for the base colors blue, green and red. The width of the transmission bands is selected in the range of 20 nm. The transmission bands of the filters are slightly shifted with respect to each other and arranged such that they do not overlap, so they are orthogonal to each other. A three dimensionally discernible image can be projected on a screen by means of the two orthogonal interference filters, each featuring three transmission bands for the three primary valences in the range of the red, green and blue color perception, creating two separate perspective partial pictures, one for the left eye and one for the right eye. The viewer perceives this image selectively through the separate eyes using glasses where the left glass features a filter characteristic according to one interference filter and the right glass a filter characteristic according to the other interference filter. Thus the two perspective partial pictures on the screen are separated for the specific eye and the stereo effect respectively the three dimensional representation of the images is created for the viewer.

In prior art the optical components for the generation respectively the reception of the left and right perspective partial picture are identical in their realization. The same optical polarization, the same optical frequency distribution and/or the same chronological activity controls are used for the generation or, as the case may be, the reception of the left perspective partial picture. For the generation or, as the case may be, the reception of the right perspective partial picture a different and complementary optical or chronological property is selected to ensure a reliable separation of the perspective partial picture (channel separation).

The objective of the invention is to provide a process for the stereoscopic replay of pictures, video clips, movies etc. or, as the case may be, a stereo projection system for the realization of such process that provides good color rendering, a reliable channel separation with low flickering and a simple and robust design.

The objective is accomplished by a process according to the characterizing portion of claim 1 and a stereo projection system according to the characterizing portion of claim 6.

Advantageous embodiments are described in the dependent claims.

According to the invention the color filters either for the generation or the reception of the two perspective partial pictures are designed or selected such that the number (b) of the transmission bands is reduced by an interval or integer (a) compared to prior art, whereas the number of the other color filters for the two perspective partial pictures is typically equal to 6 (a) thus they are selected structurally different.

The invention features precisely for one side of the system either for the image generation or the reception a number (a) of transmission intervals or bands that is reduced compared to the number (b) of transmission intervals or bands on the other side for the two perspective partial pictures that is smaller than 6 (a), specifically 5 or 4 (b). Of these 5 or less transmission bands which do not overlap each other at least one transmission band exhibits an arrangement in the range of two color perceptions—blue (B), green (G) or red (R). The other transmission bands are arranged in the frequency spectrum such that they are within the range of a single color perception, i.e. blue, green or red. These transmission bands for a color perception exhibit a bandwidth preferably in the order of 30 nm or less enabling a reliable separation and arrangement within the range of one color perception and a reliable separation from the other transmission bands. For this the transmission intervals are arranged such that there is sufficient distance between them.

With this specific arrangement and embodiment of the transmission bands the number of edges, i.e. the number of flanks of the transmission bands, can be reduced thus minimizing the complexity for the production of these filters which are typically interference filters, without a significant impact on the quality of the color rendering.

As a positive effect it is possible to simplify the design of the stereoscope with the proper design of the filter according to the invention for the process according to the invention or, as the case may be, the stereo projection system according to the invention, since this embodiment enables the reduction of the very high image refresh rates used in projectors, e.g., a Three-Chip DLP Projector with changing filters for the separation of the two perspective partial pictures. As a result a noticeable reduction of the stress on the image generating units, and hereby an improved lifetime of the projector, is achieved.

By choosing at least one transmission band such that it transmits the ranges of two color perceptions, the brightness for the projection and image replay can be enhanced which allows for suitable electronic color correction circuitry resulting in a very authentic and natural color composition of the replayed perspective partial pictures and thereby the three-dimensionally perceivable stereo image.

It has proven to be advantageous to design the interference filters of the viewing glasses not identical to the ones used in the interference filter units of the image generating components of the system but rather structurally different and at best only coordinated with each other. This allows for the utilization of targeted differences in production quality or in the design to achieve certain advantageous projection- or display-situations. To give an example, by the combination of the filters in the stereo projector and the viewing glasses such that the corresponding filters differ by a permutation of individually defined transmission intervals either in the blue, the green or the red color perception ranges, it is possible to lower the image refresh rate of the stereo projector without a noticeable flickering of the stereo images.

A particularly advantageous embodiment of the invention features interference filters of the interference filter units of the stereo projector with a permutation of defined transmission bands of the interference filters in the blue or green or red color perception range and at least one set of stereo viewing glasses with interference filters that according to the state of the art feature 6 transmission intervals which are not permutated. In the context of the above mentioned permutation an interchange of two transmission bands between corresponding interference filters (right side with left side, respectively right perspective partial picture with left perspective partial picture) takes place within one color, i.e. within one color perception range, in which additionally at least two neighboring transmission ranges merge to form a combined transmission band that covers two color perception ranges. This results in a reduction of the number of the spectral transmission bands in the interference filter of the stereo projector for example from 6 to only 5.

According to the invention an interchange of the related color image data takes place in accordance with the permutation of the transmission bands.

If for instance a permutation of the red transmission bands R1 and R2 is implemented, i.e. their interchange and the consecutive merging of the neighboring transmission band G1 with R1, then the image information, i.e. the color image data, for the projection by means of R2 is now no longer performed through the first interference filter unit but through the second interference filter unit. This results in a time delay of the replay of this “permutated” color image data, since the perspective partial pictures created by means of the interference filter units without permutation are each completely and always individually replayed in alternating order, which is not happening in the case of permutation. Due to the permutation the time delay in the replay of the two perspective partial pictures (left and right) is cancelled according to the invention. Thus the gaps between the replay of the left perspective partial picture, which stem from the fact that in this gap the other, the right perspective partial picture, is replayed, can be filled with images respectively image information in the permutated color.

According to the invention this prevents or reduces noticeable and aggravating flickering of the projected stereo images. Through this improved embodiment of the stereo projection system it is possible to reduce the undesirable high image refresh rates of the stereo projector which result in a significant stress on the components of the stereo projector, thus extending the usable life of the components of the projector.

According to the invention it is alternatively or cumulatively also possible to increase the number of the picture elements (or pixels) to increase the image resolution without a noticeable and aggravating flickering of the stereo image replay.

According to the invention it has proven to be advantageous to perform the permutation in the interference filters of the viewing glasses rather than in the interference filter units of the stereo projector. This results in advantages as already mentioned in the embodiment of the invention above.

It has proven to be specifically advantageous to select the reduced number of transmission bands for the perspective partial pictures to be equal to 5, resulting in the generation of one perspective partial picture by two transmission bands, whereas the other perspective partial picture is generated by three transmission bands, where each one is located in the range of the blue, the green and the red color perception and preferably with a bandwidth of typically less than 30 nm specifically in the range from 20 nm to 25 nm.

Furthermore to a achieve improved brightness it has proven to be advantageous to design the outer blue transmission band or, as the case may be, the outer red transmission band as open intervals towards the shorter or, as the case may be, the longer wavelengths, i.e. beyond the range typically visible for a human, or as a broad transmission band with steeply sloping flanks. This improved brightness in turn creates a “reserve” allowing for electronic measures to enhance the color perception.

The filter with the two transmission bands of which one includes two color perception ranges, namely typically red and green respectively blue and green, exhibits a reduced number of transmission bands which accordingly feature a significantly reduced number of edges, i.e. flanks for the transmission bands, i.e. only 4 instead of 6 as used in the state of the art. This reduction results in a significant simplification of the filter characteristics and enables a cost efficient and simple design of the filter without a noticeable impact on the quality of the color rendering. The steepness of the flanks of the transmission bands is a quality defining parameter for filters, particularly interference filters, with a strong influence on the cost of these filters.

Through this embodiment of the invention the filter, specifically the interference filter with less flanks through a reduction of the number of transmission bands according to the invention, and through the option to utilize open intervals for the transmission bands at the outer edges of the color perception range, it is possible to significantly reduce the complexity of the filters, in particular for the interference filters, for these processes for the generation of three-dimensional image replay or, as the case may be, for a stereo projection system.

It has proven advantageous to design the filters, in particular Fabri-Perrot interference filters, such that they exhibit a total of 4 transmission bands for the two perspective partial pictures. Each filter for one perspective partial picture features one transmission band covering two ranges of color perception. These transmission bands cover either the two color perceptions blue and green or the two color perceptions green and red. These transmission bands have a medium bandwidth of more than 30 nm. The other two transmission bands, each of which is assigned to one of the two perspective partial pictures thus assigned to one filter each, each cover only one color perception range, namely blue or red. The transmission bands are selected such that each filter or, as the case may be, each perspective partial picture receives color information for each color perception range—red, blue, green.

In this embodiment the outer transmission bands can also be designed as open intervals. This allows for a reduction of the number of edges respectively flanks through the reduction in transmission bands and by utilizing open intervals for the outer transmission bands resulting in simpler more cost efficient filters, in particular Fabri-Perrot interference filters, for the realization of a stereo projection system according to the invention.

By utilizing a bandwidth that is extended compared to prior art, that at least partially extends over 30 nm and at the same time at least partially covers the range of two color perception ranges, it is possible to replay very bright stereo projection images and therefore three dimensionally perceivable images without significant quality losses of the color rendering. This embodiment of the transmission bands provides the opportunity to create a very natural color rendering by means of electronic correction circuitry.

In a particularly advantageous embodiment of the projection system according to the invention the number of viewing glasses (stereo glasses), the number of which depends on the number of viewers who are utilizing the stereo projection system at a time, are provided with interference filters. The optical properties of the viewing glasses are selected such that they are preferably structurally different to the corresponding interference filter units in the stereo projector. This allows for an optimal utilization of the projected image information and brightness of the images, such that the viewer or viewers of the stereo projection system according to the invention are able to enjoy pleasant and bright stereo-perspective images in authentic colors.

In other words, the invention, starting with a process for the generation of an optical three-dimensionally perceivable image replay based upon known interference technology, or, as the case may be, a known corresponding stereo projection system, differentiates itself through the utilization of color filters for the image replay, i.e. in a stereo projector, a stereo display etc., that are structurally different to the color filters used for the viewing glasses, in which a different number of transmission bands is utilized. The number (a) is in particular selected to be equal to 6 as in the prior art whereas the number (b) according to the invention is selected to be smaller than (a), in particular smaller that 6.

The reduction in the number of transmission bands can be achieved for example by left/right exchanging (permutating) two narrow transmissions bands in the range of the blue (B), green (G) or red (R) color perception and then merging one of them with a neighboring transmission band to one broad transmission band, generating one transmission band which covers two different color perceptions blue (B), Green (G) or Red (R). This results in transmission bands for the color images for the image replay respectively the viewing glasses (stereo glasses) which are fundamentally identical and other transmission bands which are structurally different hence only similar.

Moreover according to the invention the left/right interchanged (permutated) image data pairs assigned to the transmission bands are additionally interchanged during the image generation such that a reliable stereoscopic separation of the stereoscopic perspective partial pictures for the left and the right eye is provided and furthermore reducing the tendency of the system to flicker during the sequential replay of the individual color image data. The system according to the invention represents a simple, robust and cost efficient design.

In the following the invention will be explained in more detail with the below listed illustrations and reference designators. The invention is not restricted to the exemplary embodiments shown in the illustrations below. They show:

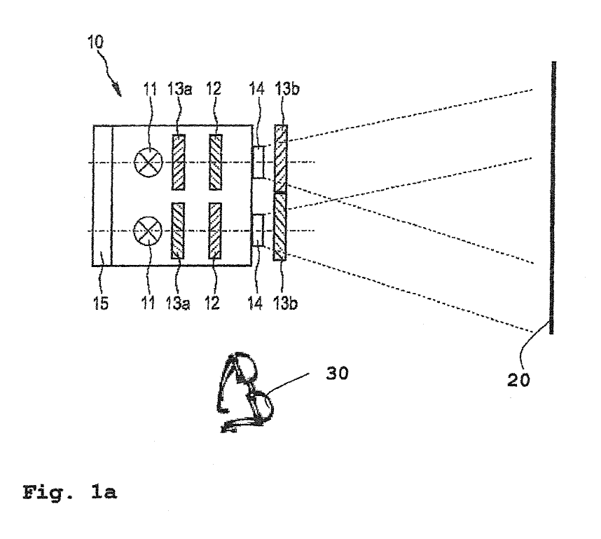

FIG. 1 A schematic representation of a stereo projection system according to the invention.

FIG. 1a A schematic representation of another stereo projection system according to the invention.

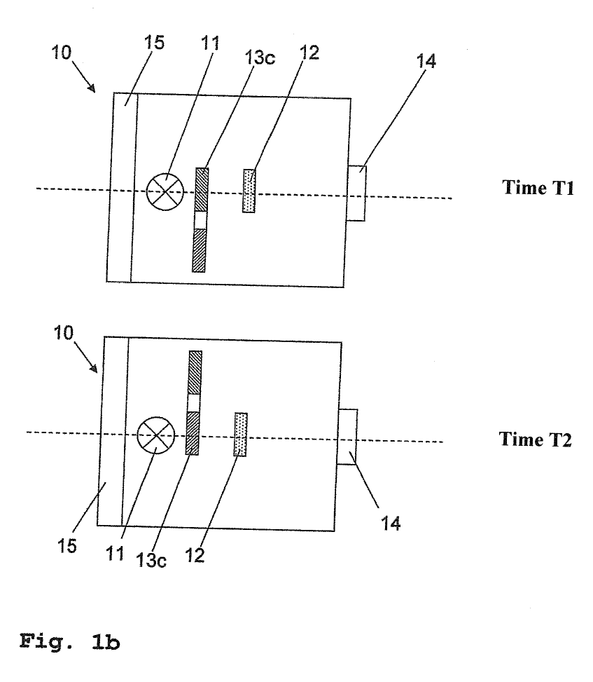

FIG. 2 Spectral transmission bands of the orthogonal filters using common interference filter technology according to the state of the art.

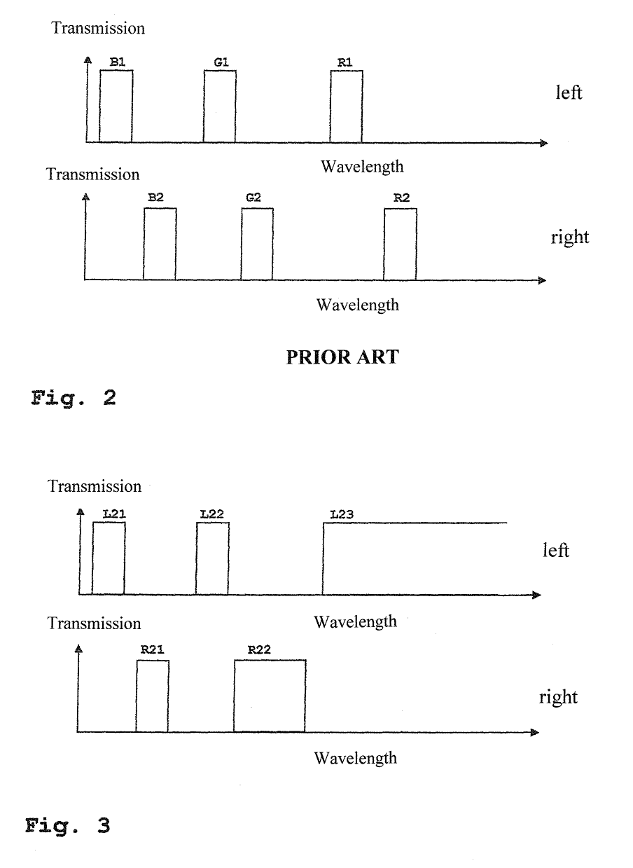

FIG. 3 An exemplary spectral distribution of the transmission bands of two interference filters according to the invention.

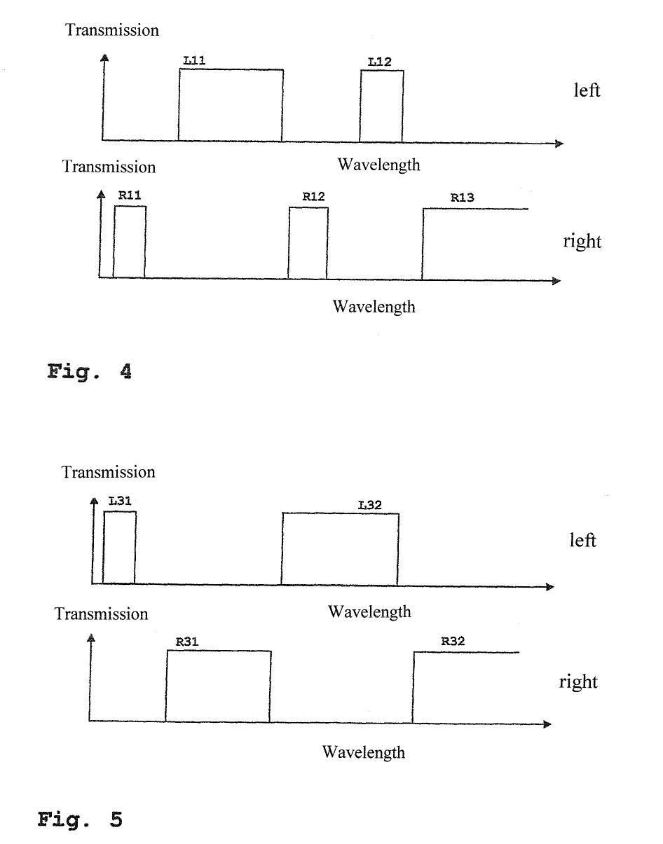

FIG. 4 A further exemplary spectral distribution of the transmission bands of two interference filters according to the invention.

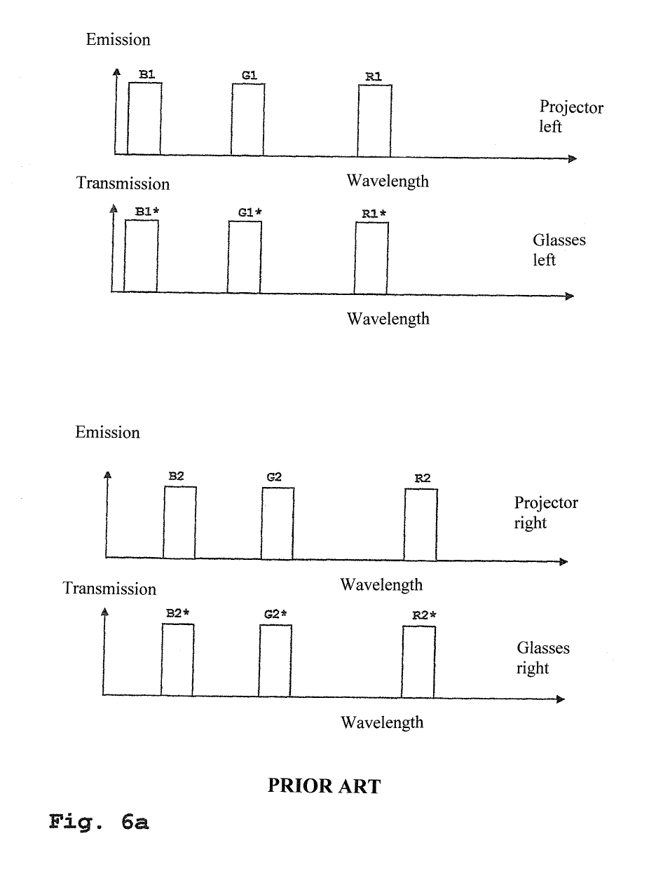

FIG. 5 A further exemplary spectral distribution of the transmission bands of two interference filters according to the invention.

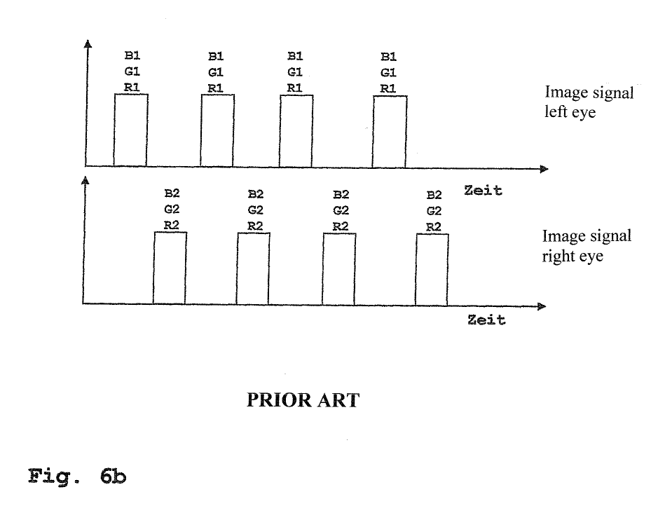

FIG. 6 A spectral distribution of the transmission bands for the viewing glasses (stereo glasses) and stereo projector according to the state of the art.

FIG. 6b A chronological sequence of the projected and perceivable color image data for the viewing (stereo glasses) and stereo projector according to the state of the art.

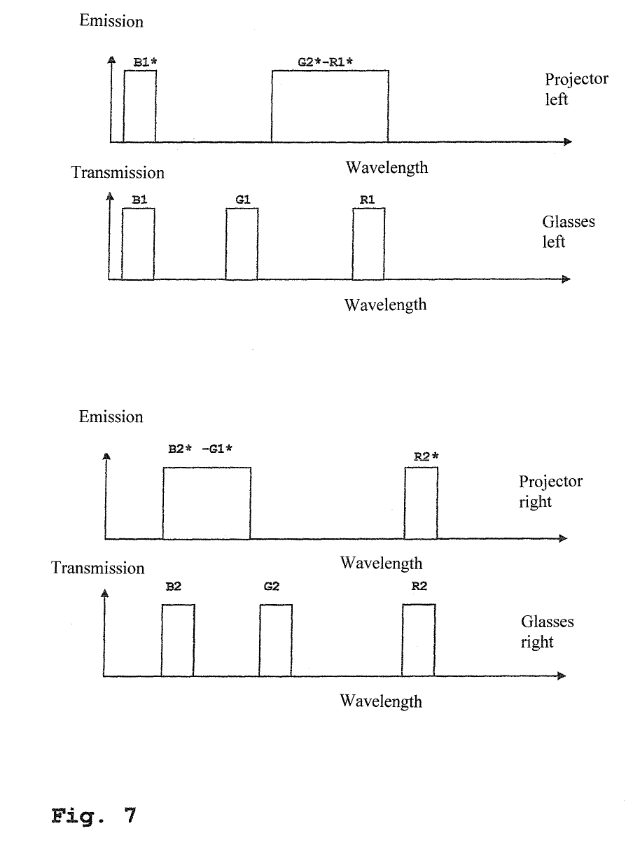

FIG. 7 A spectral distribution of the transmission bands for the viewing glasses (stereo glasses) and stereo projector for an exemplary embodiment of a stereo projection system according to the invention.

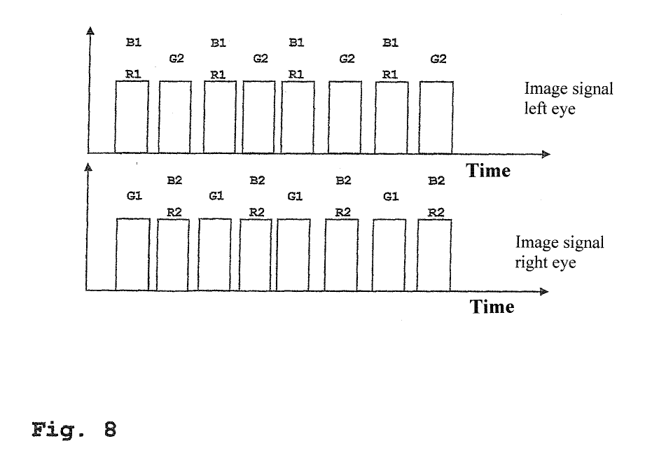

FIG. 8 A chronological sequence of the projected and perceivable color image data of an exemplary embodiment of a stereo projection system according to the invention.

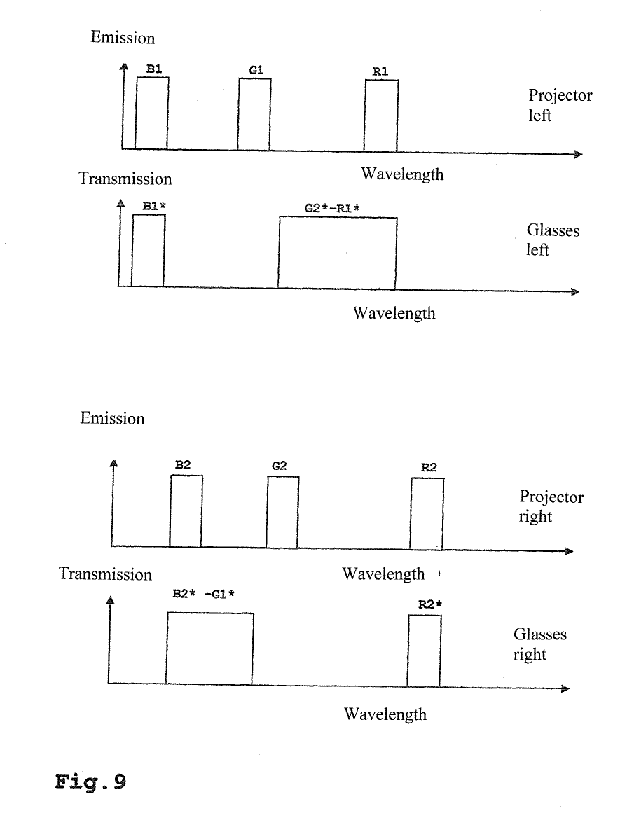

FIG. 9 A further spectral distribution of the transmission bands for the viewing glasses (stereo glasses) and stereo projector for an exemplary embodiment of a stereo projection system according to the invention.

FIG. 1 a shows the key components of the stereo projection system for the generation of an optical three-dimensionally perceivable image replay according to the invention, namely, the stereo projector (10). This stereo projector (10) projects the received image data onto a screen (20) by converting the stereo image data within the stereo projector (10) into perspective partial pictures and projecting them onto the screen (20). The two separate perspective partial pictures constitute a stereo image and a three dimensionally perceivable image. Using the viewing glasses or stereo glasses (30) this image is perceived by the viewers. By means of the stereo glasses (30) and their individual lenses the two perspective partial pictures are separated and individually differentiated transmitted to the left respectively the right eye of the viewer. The viewer receives the two stereoscopically differentiated perspective partial pictures and thus perceives a three dimensional image.

The stereo projector (10) exhibits the major functional components for the projection of the perspective partial pictures as well as an integrated color correction circuitry (15). For each of the perspective partial pictures one light source (11) in form of a metal halide lamp is utilized. The emitted light from this light source is fed into an image generating unit (12) which is constituted by an LCD-Chip. The image generating unit (12) is controlled by the stereo image data respectively by the correlating perspective partial picture data such that the desired perspective partial picture is generated from the incident broadband light from the light source (11) then passing through the projector lenses (14) onto the screen (20).

In addition the stereo projector (10) features an interference filter unit (13a) or (13b) for each perspective partial picture. The arrangement of the interference filter unit (13a) between the light source (11) and the image generating unit (12) results in a very robust and compact design whereas the alternative arrangement of the interference filter unit (13b) in front of the projection lenses (14) constitutes a very flexible but less robust and less compact design.

The color correction circuitry (15) which is integrated in the stereo projector (10) is connected to the source of the stereo image data (not shown) and corrects the input stereo image data in particular with regard to color rendering and brightness such that the color shift caused by the choice of the transmission bands of the interference filter units (13a), (13b) is corrected to a large extent.

Beyond that, the color correction circuitry (15) largely or completely corrects brightness discrepancies and other color distortions caused by the different transmission performance through the different transmission bands of the interference filter units (13a) respectively (13b) for the different perspective partial pictures. The correction includes distortions caused by the individual projection lenses (14) and/or the light source (11). This allows projecting a well balanced stereo image in authentic colors, such that the spectator is able to enjoy a pleasant viewing experience and enables three dimensional perception in a reliable and pleasant manner.

The interference filter units (13a), (13b) constitute Fabri-Perrot interference filters. They have each one filter characteristic which is orthogonal to the other. FIG. 2 shows a known filter characteristic of the two interference filter units, one for the left eye i.e. for one perspective partial picture and one for the right eye, i.e. for the other perspective partial picture, which are orthogonal to each other so they are without any overlap. Per the illustration the transmission bands B1, B2, G1, G2, R1 and R2 do not show an overlap and their spacing is selected such that the two perspective partial pictures are reliably separated for the replay. The individual transmission bands B1, B2, G1, G2, R1 and R2 are selected with a very narrow bandwidth of approximately 20 nm half-width. The two transmission bands B1 and B2 are located in the blue color perception range of the human eye, the two transmission bands G1 and G2 are located in the green color perception range and the two transmission bands R1 and R2 are located in the red color perception range. The band R2 is an outer and open transmission band with one steep edge respectively flank and another edge respectively flank which is not shown here that is not as steep.

One of the interference filter units with the transmission bands B1, G1 and R1 exhibits 6 steep edges whereas the other interference filter unit with the transmission bands B2, G2 and R2 exhibits only 5 steep edges or, as the case may be, flanks. Since these steep flanks are difficult to manufacture, they represent a major cost factor for the manufacturing of these interference filters. By using each three narrow transmission bands the projection of a pleasant stereo image with bright colors is achieved.

In FIG. 1b another embodiment of the stereo projector (10) according to the invention is shown at different points in time T1 or T2 of the projection. The stereo projector (10) shows all essential components for the projection of the perspective partial pictures and an integrated color correction circuitry (15). The sole light source (11) is a metal halide lamp. Its light is fed into one image generating unit (12) which is constituted by a DMS-Chip. The image generating unit (12) is controlled by the stereo image data or, as the case may be, the sequentially assigned perspective partial picture data such that the desired perspective partial picture is generated from the broadband light of the light source (11) and through the one projection lens (14) displayed on the screen (20).

Additionally the stereo projector (10) features a change filter which is an interference filter (13c) with two different orthogonal interference filters, one each for one perspective partial picture. These filters are positioned alternately in the optical path for the replay of the one or the other perspective partial picture. The embodiment of the interference filter unit (13c) as a change filter between the light source (11) and the image generating unit (12) results in a very robust, compact and cost efficient design.

In FIG. 3 an embodiment of the filter characteristics of the two interference filter units (13a), (13b) according to the invention is shown, in which less than 6 transmission bands, namely only 5 transmission bands L21, L22, L23, R21 and R22 are realized. Here the transmission bands L21, L22 and R21 are selected as a narrow transmission bands in the blue color perception range (L21 and R21) and in the green color perception range (L22). They exhibit a bandwidth of approximately 25 nm. L21 exhibits a half-width in the range from 425 nm to 450 nm, R21 a bandwidth from 460 nm to 485 nm as half-width and in the green color perception range the transmission band L22 exhibits a half-width from 500 nm to 525 nm.

Only the transmission band R22 is located in more than one color perception range of the human eye. It consists of parts in the green and the red color perception range and stretches over a wavelength range from 535 nm to 626 nm. Separated and spaced from R99, the transmission band L23 extends from a wavelength of 635 to more than 690 nm and represents an open interval.

Therein the two transmission bands R21 and R22 are assigned to one perspective partial picture for the right eye, whereas the three other transmission bands L21, L22 and L23 are assigned to the other perspective partial picture thus the left eye.

This filter characteristic results in a reduced number of transmission bands and furthermore a reduced number of steep edges respectively flanks. The number of transmission bands is reduced to 5 and the number of steep edges is reduced to 9. The complexity for the realization of these filter characteristics is significantly reduced without a significant impact on the quality of the color rendering. Quite the contrary, the improved brightness by means of the broad range of the of the transmission range R22 allows an increased brightness to be achieved which then allows for the use of a color correction circuitry thus enabling an additional improvement of the color characteristics.

Based on the color characteristic according to prior art with 6 transmission bands, the color characteristic according to the invention is characterized by channel permutation namely by an interchange of the transmission range R1 from one perspective partial picture to the other and merging of R1 with G2 as well as assigning the transmission band R2 to the other perspective partial picture.

Accordingly the filter characteristic shown in FIG. 4 originates from the filter characteristic shown in FIG. 2 by assigning the transmission band B1 to the other perspective partial picture and merging of the transmission bands B2 and G1 for partial picture 1. The result is a filter characteristic that is created similar to FIG. 3 and which exhibits the corresponding, comparable advantages. In contrast to the aforementioned filter characteristic, here the transmission band L11 stretches across the two color perception ranges blue and green, whereas the other transmission bands only cover one color perception range. The band L11 exhibits a bandwidth from 46 nm to 525 nm, R11 a bandwidth from 535 nm to 565 nm, and the band L12 a bandwidth from 595 m to 626 nm. The band R13 is an open interval with a larger bandwidth from 635 nm to 690 nm. Also this filter characteristic is characterized by a reduction of the transmission bands and a significant reduction of steep flanks minimizing the complexity for the realization of such a filter characteristic.

FIG. 5 shows another embodiment of a filter characteristic according to the invention, namely a filter characteristic with only 4 transmission intervals with two of them covering each two color perception ranges and the other two only covering one color perception range each respectively are located in only one color perception range. The band L31 for the left eye and the band R32 for the right eye are each located in only one color perception range, namely the blue color perception range respectively the red color perception range. The band L31 stretches from below 420 nm to approximately 450 nm and R32 in the red color perception range from 635 nm to beyond 690 nm. The transmission band R32 constitutes a so-called open interval with a flat edge respectively a flat upper edge respectively flank in the range above 690 nm. The two other bands that stretch over two color perception ranges exhibit an extended bandwidth. This bandwidth is significantly larger than 30 nm. The interval L32 covers the green as well as the red color perception range and stretches from approximately 535 nm to 626 nm. The band R31 covers the blue and green color perception range and stretches from approximately 460 nm to 525 nm. Through this embodiment of the filter characteristic of the two interference filters an orthogonal filter characteristics is given that results in a significantly reduced number of transmission bands namely 4 and furthermore reduces the number of steep flanks to 7 resulting in a simplified process for the production of the filter characteristic. However this filter characteristic still provides a very pleasant color rendering for stereo projection systems.

FIG. 6a shows the transmission bands of a stereo projector and of the according stereo glasses according to prior art. The stereo glasses show 6 narrow, limited transmission bands B1*, G1*, R1* and B2*, G2*, R2*. The interference filter units of the stereo projector also show 6 transmission bands that are identical to the stereo glasses B1, G1, R1 and B2, G2, R2. In this the x1 bands (x=B, G, R) are each assigned to the left perspective partial picture and the “left” components of the stereo projector whereas the x2 bands are assigned to the “right” components. It is evident that the x1 bands are orthogonal to the x2 bands.

FIG. 6b shows a chronological sequence of the replayed or, as the case may be, perceivable image contents of the individual perspective partial pictures according to prior art. This sequence as an example is generated with a stereo projection system according to FIG. 1b. The perceivable partial pictures are replayed and projected alternatingly by the stereo projection system with the interference filters according to FIG. 6a.

First, the left perspective partial picture with the color image data B1, G1, R1 is replayed and projected by means of the according transmission bands. During this time there is no projection of an image respectively image data of the right perspective partial picture. Hence there is no right perspective partial picture perceivable. Subsequently the right perspective partial picture with the color image data B2, G2, R2 is replayed and projected by means of the corresponding transmission bands. During this time period the left perspective partial picture is not displayed. Consequently only the right perspective partial picture can be seen through the right lens of the stereo glasses and no information of the left perspective partial picture is perceived.

This is then followed by the replay of the other perspective partial picture and the according interruption of the replay of the perspective partial picture of the other channel.

The alternating replay of the perspective partial pictures results in considerable gaps for the perception of the particular image for the particular eye which, once these gaps get too long, results in annoying flickering. In order to prevent flickering, the image refresh rate of the stereo projector needs to be high. This high refresh rate leads to significant stress for the components of the stereo projector. This stress in turn reduces the usable life of the stereo projector and results in decreased reliability. This also holds true for an additional filter changing mechanism according as shown in FIG. 1b. in order to mitigate these disadvantages significant and costly measures are necessary.

FIG. 7 shows according to the FIG. 5 a spectral distribution according to the invention of the interference filter spectra for the interference filters of the interference filter units of the stereo projector or, as the case may be, the interference filters of the lenses of the stereo glasses.

The characteristics of the interference filters of the lenses of the stereo glasses shows 6 narrow bands according to the prior art, whereas the bands of the interference filters of the stereo projector are according to the invention structurally different and exhibit only 4 transmission bands. The stereo projector interference filter for the left perspective partial picture exhibits a narrow band B1*, whereas the other band based on a permutation of G1* with G2* by merging of the bands G2* and R1* exhibits a relatively broad band.

Accordingly a merged band G1* with B2* was created for the stereo projector interference filter of the right perspective partial picture which is supplemented by the single narrow band R2*. The merged transmission bands cover two color perception ranges.

In this B1 and B1* respectively R2 and R2* are largely identical whereas other transmission bands are structurally and substantially different and are at best only equivalent to each other.

According to FIG. 8, this embodiment according to the invention also features a permutation of the color image data such that the in the following listed advantages according to the invention can be achieved.

FIG. 8 shows the chronological sequence of the replayed and perceivable stereo image data or, as the case may be, color image data for the left eye or, as the case may be, the right eye of a stereo projection system according to the invention, wherein a stereo projector according to FIG. 1b is used.

FIG. 8 is based upon a spectral distribution of the transmission bands as shown in FIG. 7 for the interference filter units in a stereo projection system.

By permutation of the band G1 with G2 the broad band R31 between G1 and B2 covering two color perception ranges was formed. The permutated band G2 is merged with band R1 to form band L32 and includes two color perception ranges as well. This permutation and the subsequent two mergers results in a configuration that exhibits four transmission bands for the both interference filter units of the stereo projector.

If in addition the color image data which is assigned to the band G2 is permutated onto the band G1 so it is replayed with the other interference filter unit, then an alternating replay and therefore perception of the color image data in the left eye or, as the case may be, the right eye in which the color image data for the green color perception range alternates with the data of the other color perception ranges red and blue is achieved. Based upon the additional permutation of the color image data the left eye can only receive the data for the left eye and the right eye accordingly only the data for the right eye. It should be noted that according to the invention no permutation of the 6 transmission bands of the stereo glasses took place so that their optical properties correspond to the optical properties of the non-permutated interference filters of the interference filter units in the stereo projector. By applying the described process the gaps in the replay for the individual eye as in the prior art can be closed and the undesirable flickering considerably reduced.

The color image data set R1, B2 is followed in close order by the color image data set G2 then followed by the color image data R1, B1 G1 etc. This is the sequence for the left eye and the sequence for the right eye follows accordingly.

By elimination of the long gaps without a distinct negative light stimulus by a distinct dark phase a significant quality improvement is achieved. It is particularly advantageous that the negative aspects of the physiological delay of the perception of images are diminished in this embodiment according to the invention since the interruptions of the brightness are very brief hence only limited or not activated according to the invention. With that it is physiologically possible to largely perceive the replayed brightness which is not the case in the prior art resulting in a reduced perceived brightness. According to the invention a subjectively brighter stereo image is perceived.

Through this embodiment of the stereo projection system according to the invention a reduction of the image refresh rate respectively if needed an increase of the resolution of the replayed stereo images can be achieved without an increased flickering. Depending on the application this can be done alternatively or in combination. In this the relation between the image refresh rate and the image resolution needs to be taken into account. Their product represents the constant maximum bandwidth of the replayed images. Accordingly the image resolution for instance can be increased, by decreasing the image refresh rate.

The stereo projection system according to the invention as described above provides a very comfortable and enjoyable perception of stereo images. In addition it features a long usable life and a simple and cost efficient realization.

FIG. 9 shows another embodiment of a stereo projection system according to the invention. FIG. 9 shows according to the FIG. 6 a spectral distribution according to the invention of the interference filter spectra for the interference filters of the interference filter units of the stereo projector or, as the case may be, the interference filters of the lenses of the stereo glasses.

The characteristic of the transmission bands of the stereo projector exhibits 6 narrow bands according to prior art, whereas the interference filters of the stereo glasses lenses exhibit only 4 transmission bands. The left lens exhibits a narrow band B1*, whereas the other band is generated by the permutation of G1* with G2* by merging of the band G2* with the band R1*.

Likewise the merged transmission band G1* with B2* for the right lens is generated and supplemented by the single narrow band R2*. The merged intervals cover each two color perception ranges. Similar to FIG. 8, a permutation of the color image data is also utilized in this embodiment according to the invention such that the corresponding aforementioned advantages are also valid for this embodiment.

The production and cost advantages are even more pronounced since in this case a larger potential number of stereo glasses with a reduced number of transmission bands could be assigned to one stereo projector with two interference filter units, resulting in tangible cost advantages on one hand and appreciable quality improvements on the other hand.

Utilizing the aforementioned filter characteristics according to the invention it is possible to reduce the high image refresh rates used in prior art e.g. for three-chip DLP projectors with change filters thus increasing the maximum number of pixels respectively increasing the reliability of these stereo projectors and increase the usable life as well the robustness of these stereo projection systems according to the invention significantly.

1. A process for the generation of an optically three-dimensionally perceivable image replay, in which for each of the two perspective partial pictures (left, respectively right), by means of color filters, different predetermined ranges of the visible spectrum are masked, such that multiple limited spectral bands in the range of the color perception blue (B), green (G) and red (R) are transmitted,
wherein the location of the transmission bands for the two perspective partial pictures is different,
wherein during the image generation and during image reception by means of stereo glasses color filters are utilized for the perspective partial pictures,
wherein the number of transmission bands for the color filters for the image generation, as compared to the color filters for the image reception by means of stereo glasses, is different,
wherein the number of the transmission bands for the two perspective partial pictures (a) are selected to be preferably smaller than 6, wherein at least one transmission band for one of the perspective partial pictures is selected transmitting in the range of two color perceptions blue (B), green (G) or red (R),
wherein the overall number (b) of the transmission bands for the two perspective partial pictures is selected larger than (a) and in particular equal to 6,
wherein the transmission bands of the color filters for the image generation and for the stereo glasses are fundamentally of identical design and others are designed equivalent, in that for the image generation or for the stereo glasses individual transmission bands are interchanged or alternated pair-wise left/right, and by merging with a neighboring band the overall number is reduced, and
wherein the range data associated with the pair-wise right-left interchanged hands is additionally right-left interchanged during image generation.

2. The process for the generation of an optically three-dimensionally perceivable image replay according to claim 1,
wherein for the color filters of the image generation or the image perception the number b of the transmission bands (L11, L12, R11, R12, R13; L21, L22, L23, R21, R22) for the two perspective partial pictures is selected to be equal to 5, and
wherein one transmission band (L11; R22) for one of the perspective partial pictures is selected transmitting with a bandwidth of greater than 30 nm in the range of the two color perceptions blue (B) and green (G) or in the range of the two color perceptions green (G) and red (R).

3. The process for the generation of an optically three-dimensionally perceivable image replay according to claim 1, wherein the transmission bands (L12, R11, R12, R13; L21, L22, L23, R21) are selected with a bandwidth of approximately 30 nm or less than 30 nm in the range of a single color perception blue (B), green (G) or red (R).

4. The process for the generation of an optically three-dimensionally perceivable image replay according to claim 1,
wherein for the color filters of the image generation or the image perception the number (b) of the transmission bands (L31, L32, R31, R32) for the two perspective partial pictures is selected equal to 4, and
wherein one transmission band each (L32; R31) for one of the perspective partial pictures is selected transmittant with a bandwidth of greater than 30 nm in the range of the two color perceptions blue (B) and green (G) or in the range of the two color perceptions green (G) and red (R) and that one transmission band each (L31; R32) for one of the perspective partial pictures is located in the range of a single color perception blue (B) or red (R).

5. The process for the generation of an optically three-dimensionally perceivable image replay according to claim 1, wherein at least one of the two outer transmission bands is designed as an open interval.

6. A stereo projection system for the generation of an optically three-dimensionally perceivable image replay with a stereo projector (10) suitable for the projection of two perspective partial pictures (left respectively right) onto a screen, with at least one light source (11), with at least one image generating unit (12) for each perspective partial picture, and with two orthogonal interference filter units (13a, 13b) through which different predetermined ranges of the visible spectrum are blocked out such that multiple limited spectral bands are transmitted in the range of the color perception blue (B), green (G) and red (R) in which the location of the transmission bands is different for the two perspective partial pictures,
wherein the color filters of the stereo projector are designed such that the number (b) of the transmission bands for the two perspective partial pictures is selected smaller than 6 and that at least one transmission band for one of the perspective partial pictures is selected transmitting in the range of two color perception ranges blue (B), green (G) or red (R),
wherein at least one set of stereo glasses is utilized with lenses that are, with respect to the transmission characteristic for the left and the right eye of the viewer, substantially identical or equivalent to the two orthogonal interference filter units and feature at least 6 limited spectral bands which are pair-wise transmitting in the range of the color perception blue (B), green (G) and red (R) in which the location of the transmission bands is different,
wherein the left perspective partial picture is generated with the color image data R1 G1, B1 and the right perspective partial picture is generated with the color image data R2, G2, B2 by means of the image generating unit of the stereo projector, in which R1 and R2 constitute color image data with red color, G1 and G2 color image data with green color and B1 and B2 color image data with blue color,
wherein color image data of one color of the two perspective partial pictures is pair-wise left-right exchanged such that the interchanged right color image data is replayed for the left perspective partial picture by means of the interference filter unit and vice versa, that the interference filter unit of the stereoprojector is so designed, that at least a part of the exchanged color image data in the range of one transmitted interval is transmitted and projected in the range of two color perceptions, and
wherein the stereo projector is designed such that perspective pictures can be projected by means of alternating use of the two interference filter units.

7. The stereo projection system for the generation of an optically three-dimensionally perceivable image replay with a stereo projector (10) suitable for the projection of two perspective partial pictures (left respectively right) onto a screen with at least one light source (11), with at least one image generating unit (12) for each perspective partial picture and with two orthogonal interference filter units (13a, 13b) through which different predetermined ranges of the visible spectrum are blocked out such that multiple limited spectral bands are transmitted in the range of the color perception blue (B), green (G) and red (R), wherein the location of the transmission bands is different for the two perspective partial pictures, wherein at least one set of stereo glasses is utilized with lenses that are, with respect to the transmission characteristic for the left and the right eye of the viewer, equivalent to the two orthogonal interference filter units,
wherein the number (b) of the transmission bands of the stereo glasses is selected to be smaller than 6, wherein at least one transmission band for one of the perspective partial pictures is selected transmitting in the range of two color perception ranges blue (B), green (G) or red (R),
wherein the stereo projector features interference filter units with transmission characteristics for the left and right perspective partial picture which are equivalent to that of the two lenses of the stereo glasses and feature at least 6 (a) limited spectral bands which are transmitting pair wise in the range of the color perception blue (B), green (G) and red (R), in which the location of these transmission bands is different,
wherein the left perspective partial picture is replayed utilizing the color image data R1, G1, B1 and the right perspective partial picture is replayed utilizing the color image data R2, G2, B2 by means of the image generating unit of the stereo projector in which R1 and R2 constitute color image data with red color, G1 and G2 color image data with green color and B1 and B2 color image data with blue color,
wherein color image data of one color of the two perspective partial pictures is pair wise left-right interchanged such that the interchanged right color image data is replayed for the left perspective partial picture by means of the interference filter unit of the stereo projector and vice versa,
wherein the interference filters for the lenses of the stereo glasses are designed such that at least one part of the interchanged color image data in the range of one transmission band is transmitted in the range of two color perception ranges, and
wherein the stereo projector is designed such that perspective pictures can be projected by means of alternating use of the two interference filter units.

8. The stereo projection system for the generation of an optically three-dimensionally perceivable image replay according to claim 6,
wherein the two orthogonal interference filter units (13a, 13b) of the stereo projector or the stereo glasses are designed such that
the number of the transmission bands (L11, L12, R11, R12, R13; L21, L22, L23, R21, R22) for the two perspective partial pictures is selected to be equal to 5 and one transmission band (L11; R22) for one of the perspective partial pictures is selected transmitting with a bandwidth of over 30 nm in the range of the two color perceptions blue (B) and green (G) or in the range of the two color perceptions green (G) and red (R), and
transmission bands (L12, R11, R12, R13; L21, L22, L23, R21) are selected with a bandwidth of approximately 30 nm or less than 30 nm in the range of a single color perception blue (B), green (G) or red (R).

9. The stereo projection system for the generation of an optically three-dimensionally perceivable image replay according to claim 6,
wherein
the two orthogonal interference filter units (13a, 13b) of the stereo projector or the stereo glasses are designed such that
the number of the transmission bands (L31, L32; R31, R32) for the two perspective partial pictures is selected equal to be 4,
each one transmission band (L32; R31) for one of the perspective partial pictures is selected transmitting with a bandwidth of over 30 nm in the range of the two color perceptions blue (B) and green (G) or in the range of the two color perceptions green (G) and red (R), and
each one transmission band (L31, R32) for one of the perspective partial pictures is located in the range of a single color perception blue (B) or red (R).
